(19) United States
(12) Patent Application Publication
(10) Pub. No.: US 2026/0313750 A1
(43) Pub. Date: Oct. 8, 2026

(54) SYSTEM FOR IDENTIFYING AND SWITCHING TO AN IDEAL CELLULAR NETWORK FOR A VEHICLE

(71) Applicant: GM Global Technology Operations LLC, Detroit, MI (US)

(72) Inventors: Eric T. Hosey, Rochester Hills, MI (US); Matthew Edward Gilbert-Eyres, Rochester Hills, MI (US); Scott Thomas Droste, West Bloomfield, MI (US)

(21) Appl. No.: 19/170,389

(22) Filed: Apr. 4, 2025

(51) Int. Cl. H04W 76/50; H04W 4/029; H04W 4/90

(52) U.S. Cl. CPC H04W 76/50; H04W 4/029; H04W 4/90

(57) ABSTRACT

A cellular communication system for a vehicle that wirelessly connects to one of a plurality of cellular networks includes one or more controllers including a plurality of subscriber profiles that each correspond to one of the plurality of cellular networks. The one or more controllers include one or more processors that execute instructions to activate a subscriber profile corresponding to an ideal cellular network to establish wireless communication between the vehicle and the ideal cellular network in response to determine one of the following: a new geofenced area is declared as a disaster area, the vehicle is initiating emergency communication while located in the new geofenced area, and the vehicle is performing a connected service feature that requires the highest level of cellular connectivity available while in the new geofenced area.

### INTRODUCTION

The present disclosure relates to systems and methods for switching from a prioritized cellular network to an ideal cellular network for a vehicle, as well as identifying the ideal cellular network based on crowdsourced cellular performance data.

Many in-vehicle functions such as, for example, contacting emergency services, making telephone calls, and supervised automated driving rely upon cellular networks or cellular carrier systems to provide cellular communications. Different geographical locations experience distinct levels of cellular service and coverage for a particular cellular carrier that depend upon on a variety of factors such as, but not limited to, proximity to the particular cellular carrier's antennas, obstructions such as large buildings and dense vegetation, network congestion, and weather conditions. As a result, cellular connectivity for a contracted or prioritized cellular carrier may be strong in one particular location but as a vehicle changes its location relative to the prioritized cellular carrier's network antennas, the cellular connectivity via the prioritized cellular carrier may not be sufficient to perform some in-vehicle functions. However, there may be other cellular carriers available within the vehicle's location that are able to provide the cellular connectivity required.

Thus, while current cellular communication systems achieve their intended purpose, there is a need in the art for an improved approach for identifying and connecting to cellular networks that provide the cellular connectivity required by various in-vehicle functions.

### SUMMARY

According to several aspects, A cellular communication system for a vehicle that wirelessly connects to one of a plurality of cellular networks is disclosed. The cellular communication system includes one or more controllers including a plurality of subscriber profiles that each correspond to one of the plurality of cellular networks, where each subscriber profile allows for the one or more controllers to establish wireless communication with a particular one of the plurality of cellular networks. The one or more controllers include one or more processors that execute instructions to monitor a current location of the vehicle, where the current location of the vehicle corresponds to a current geofenced area within a surrounding environment of the vehicle, and a subscriber profile corresponding to a prioritized cellular network for the current geofenced area is active to establish wireless communication between the vehicle and the prioritized cellular network. The one or more controllers determine the vehicle is leaving the current geofenced area for a new geofenced area and determine one of the following: the new geofenced area is declared as a disaster area, the vehicle is initiating emergency communication while located in the new geofenced area, and the vehicle is performing a connected service feature that requires the highest level of cellular connectivity available while in the new geofenced area. In response to determining one of the following: the new geofenced area is declared as a disaster area, the vehicle is initiating emergency communication while located in the new geofenced area, and the vehicle is performing the connected service feature, the one or more controllers activate a subscriber profile corresponding to an ideal cellular network to establish wireless communication between the vehicle and the ideal cellular network.

In another aspect, the one or more controllers execute instructions to determine one of the following: the vehicle has exited the disaster area, the vehicle has completed the emergency communication, and the vehicle has completed performing the connected service feature, switch from the ideal cellular network to the prioritized cellular network by activating the subscriber profile corresponding to the prioritized cellular network to re-establish wireless communication between the vehicle and the prioritized cellular network.

In yet another aspect, the emergency communication is one of the following: a telephone call, a short message service (SMS) text message, a packet connection, and a message queuing telemetry transport (MQTT) connection.

In an aspect, the connected service feature represents an in-vehicle function that requires continuous cellular reception to send and receive data.

In another aspect, the connected service feature includes one of the following: supervised automated driving, remote driving, and fully autonomous driving.

In yet another aspect, the ideal cellular network is determined based on evaluating crowdsourced cellular performance data collected by a plurality of crowdsourced vehicles.

In an aspect, the crowdsourced cellular performance data is collected from crowdsourced vehicles that include one of the following: more than one available subscriber profile and one subscriber profile but the crowdsourced vehicle is not performing an in-vehicle function that requires connection to the ideal cellular network.

In another aspect, cellular connectivity parameters that are indicative of the ideal cellular network include a received signal strength indicator (RSSI) and a bit error rate.

In yet another aspect, the prioritized cellular network is a contracted cellular carrier for the vehicle.

In an aspect, the ideal cellular network includes the highest-ranked cellular performance when compared to each of the plurality of cellular networks.

In another aspect, the vehicle is an automobile.

In yet another aspect, the vehicle is one of the following: a drone, a military vehicle, a marine vehicle, and an aircraft.

In an aspect, the one or more controllers of the vehicle store a list of available geofenced areas within the surrounding environment in memory.

In another aspect, each available geofenced area that is part of the list indicates at least one prioritized cellular network.

In an aspect, a method for wirelessly connecting a vehicle to one of a plurality of cellular networks is disclosed. The method includes monitoring, by one or more controllers, a current location of the vehicle, where the current location of the vehicle corresponds to a current geofenced area within a surrounding environment of the vehicle, and the one or more controllers include a plurality of subscriber profiles that each correspond to one of the plurality of cellular networks and each subscriber profile allows for the one or more controllers to establish wireless communication with a particular cellular network. The method includes determining the vehicle is leaving the current geofenced area for a new geofenced area, wherein a subscriber profile corresponding to a prioritized cellular network for the current geofenced area is active to establish wireless communication between the vehicle and the prioritized cellular network. The method also includes determining one of the following: the new geofenced area is declared as a disaster area, the vehicle is initiating emergency communication while located in the new geofenced area, and the vehicle is performing a connected service feature that requires the highest level of cellular connectivity available while in the new geofenced area. In response to determining one of the following: the new geofenced area is declared as a disaster area, the vehicle is initiating emergency communication while located in the new geofenced area, and the vehicle is performing the connected service feature, the method includes activating a subscriber profile corresponding to an ideal cellular network to establish wireless communication between the vehicle and the ideal cellular network.

In another aspect, in response to determining one of the following: the vehicle has exited the disaster area, the vehicle has completed the emergency communication, and the vehicle has completed performing the connected service feature, the method includes switching, by the one or more controllers from the ideal cellular network to the prioritized cellular network by activating the subscriber profile corresponding to the prioritized cellular network to re-establish wireless communication between the vehicle and the prioritized cellular network.

In yet another aspect, a cellular communication system for a vehicle that wirelessly connects to one of a plurality of cellular networks is disclosed. The cellular communication system includes one or more controllers including a plurality of subscriber profiles that each correspond to one of the plurality of cellular networks, where each subscriber profile allows for the one or more controllers to establish wireless communication with a particular cellular network. The one or more controllers include one or more processors that execute instructions to monitor a current location of the vehicle, wherein the current location of the vehicle corresponds to a current geofenced area within a surrounding environment of the vehicle, and where a subscriber profile corresponding to a prioritized cellular network for the current geofenced area is active to establish wireless communication between the vehicle and the prioritized cellular network. The one or more controllers determine the vehicle is leaving the current geofenced area for a new geofenced area and determine one of the following: the new geofenced area is declared as a disaster area, the vehicle is initiating emergency communication while located in the new geofenced area, and the vehicle is performing a connected service feature that requires the highest level of cellular connectivity available while in the new geofenced area. In response to determining one of the following: the new geofenced area is declared as a disaster area, the vehicle is initiating emergency communication while located in the new geofenced area, and the vehicle is performing the connected service feature, the one or more controllers activate a subscriber profile corresponding to an ideal cellular network to establish wireless communication between the vehicle and the ideal cellular network. In response to determining one of the following: the vehicle has exited the disaster area, the vehicle has completed the emergency communication, and the vehicle has completed performing the connected service feature, the one or more controllers switch from the ideal cellular network to the prioritized cellular network by activating the subscriber profile corresponding to the prioritized cellular network to re-establish wireless communication between the vehicle and the prioritized cellular network.

In another aspect, the emergency communication is one of the following: a telephone call, a SMS text message, a packet connection, and a MQTT connection.

In yet another aspect, the connected service feature represents an in-vehicle function that requires continuous cellular reception to send and receive data.

In an aspect, the ideal cellular is determined based on evaluating crowdsourced cellular performance data collected by a plurality of crowdsourced vehicles.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a schematic diagram of an exemplary cellular communication system including a vehicle having one or more controllers, a plurality of cellular networks, one or more remote computers, and a plurality of crowdsourced vehicles, according to an exemplary embodiment; and

FIG. 2 is a process flow diagram illustrating a method for switching from a prioritized cellular network to an ideal cellular network by the one or more controllers of the vehicle shown in FIG. 1, according to an exemplary embodiment.

### DETAILED DESCRIPTION

The following description is merely exemplary in nature and is not intended to limit the present disclosure, application, or uses.

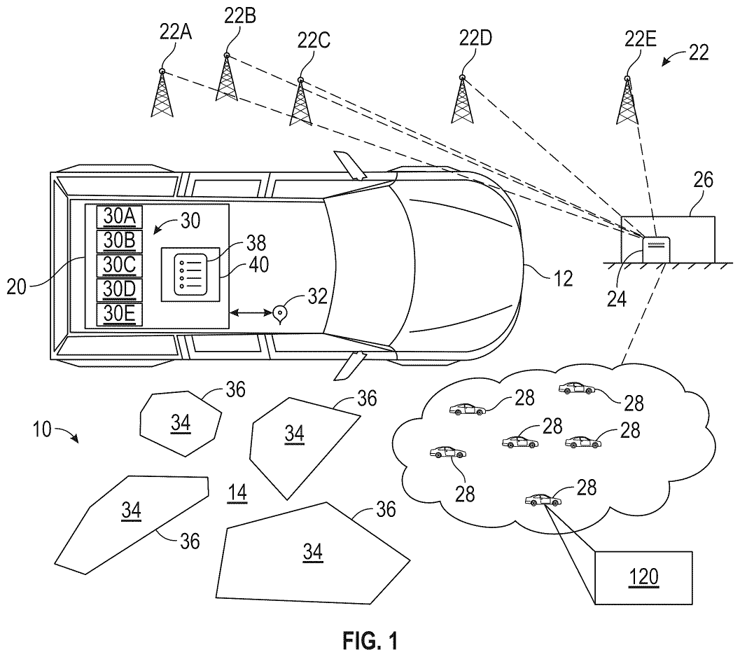

Referring to FIG. 1, a cellular communication system 10 for a vehicle 12 is shown. In the non-limiting embodiment as shown in FIG. 1, the cellular communication system 10 includes one or more controllers 20 that are part of the vehicle 12, a plurality of cellular networks 22, one or more remote computers 24 located at a back-end office 26, and a plurality of crowdsourced vehicles 28 that are each in wireless communication with the one or more remote computers 24. It is to be appreciated that each individual cellular network 22 is associated with a unique cellular provider. As explained below, the one or more remote computers 24 rank the cellular performance of the plurality of cellular networks 22 based on crowdsourcing cellular performance data collected by the plurality of crowdsourced vehicles 28 to identify an ideal cellular network 22 that provides the highest-ranked cellular performance. FIG. 1 illustrates the vehicle 12 as an automobile such as, but not limited to, a sedan, a truck, sport utility vehicle, van, or motor home. However, it is to be appreciated that the cellular communication system 10 is not limited to an automobile and the vehicle 12 may be another type of self-propelling machine as well. For example, in another embodiment, the vehicle 12 may be a drone, a military vehicle such as a tank, a marine vehicle such as a ship, or an aircraft.

In the non-limiting embodiment as shown in FIG. 1, the one or more controllers 20 of the vehicle 12 includes a plurality of subscriber profiles 30 that each correspond to one of the cellular networks 22. Each subscriber profile 30 allows for the one or more controllers 20 to establish wireless communication with a particular cellular network 22. In the embodiment as shown in FIG. 1, there are five cellular networks 22A-22E, and therefore the one or more controllers 20 of the vehicle 12 includes five subscriber profiles 30A-30E. However, it is to be appreciated that FIG. 1 is merely exemplary in nature and the cellular communication system 10 is not limited to a particular number of cellular networks 22. The plurality of subscriber profiles 30 each indicate information such as, for example, the identity of the vehicle 12, a service profile indicating the services a particular subscriber is entitled to, authentication data, and network settings corresponding to the particular cellular network 22.

It is to be appreciated that a single subscriber profile 30 may be active at any given instance. In other words, once one of the subscriber profiles 30 are active, the remaining subscriber profiles 30 are inactive and are not in use. Accordingly, it follows that the one or more controllers 20 of the vehicle 12 are connected to a single cellular network 22 at any given instance. As explained below, the one or more controllers 20 of the vehicle 12 are normally connected to a prioritized cellular network 22 that is selected based on economy. However, in response to determining the vehicle 12 is entering a disaster area, initiating emergency communication, or performing a connected service feature that requires the highest level of cellular connectivity reliability available, then the one or more controllers 20 connect to the ideal cellular network 22. The ideal cellular network 22 includes the highest-ranked cellular performance when compared to each of the plurality of cellular networks 22. The cellular network 22 having the highest-ranked cellular performance is determined by the one or more remote computers 24 based on evaluating the crowdsourced cellular performance data collected by the plurality of crowdsourced vehicles 28, which is described in below.

The vehicle 12 may include a global positioning system (GPS) 32, where the one or more controllers 20 are in electronic communication with the GPS 32. As seen in the FIG. 1, the surrounding environment 14 of the vehicle 12 includes two or more geofenced areas 34, where each geofenced area 34 is defined by a virtual geographic boundary 36. The one or more controllers 20 of the vehicle 12 store a list 38 of available geofenced areas 34 within the surrounding environment 14 in memory 40. Each available geofenced area 34 that is part of the list 38 stored in memory 40 indicates at least one prioritized cellular network 22. The prioritized cellular network 22 represents the most economical cellular network 22 for the vehicle 12 to wirelessly connect to when compared to the remaining cellular networks 22. In one embodiment, the prioritized cellular network 22 is the contracted cellular carrier for the vehicle 12. In the event the list 38 indicates more than one prioritized cellular network 22 for a particular geofenced area 34, then the list 38 ranks each prioritized cellular network 22 in descending order based on economy. Upon entering one of the geofenced areas 34, the one or more controllers 20 of the vehicle 12 connect to the highest ranked prioritized cellular network 22 indicated by the list 38 saved in memory 40.

The list 38 of the geofenced areas 34 may be saved within the memory 40 of the one or more controllers 20 during manufacturing. In one embodiment, the list 38 is updated periodically based on data received by the one or more remote computers 24 via one of the cellular networks 22. In embodiments, the list 38 is updated once a predefined period of time has elapsed since the last update, or when a predefined event such as leaving a geofenced area 34 has occurred.

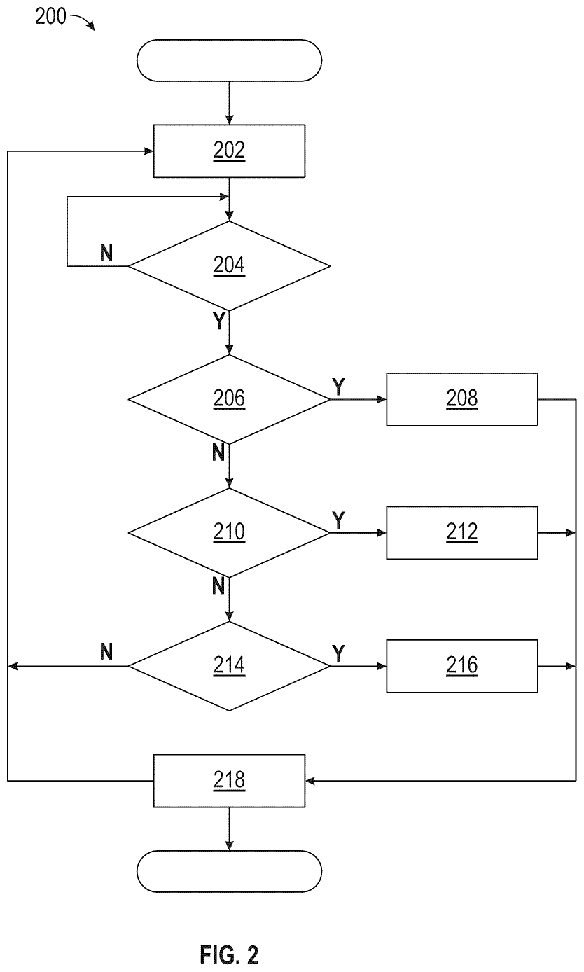

FIG. 2 is a process flow diagram illustrating a method 200 for switching from the prioritized cellular network 22 to the ideal cellular network 22 by the one or more controllers 20 of the vehicle 12. Referring to both FIGS. 1 and 2, the method 200 may begin at block 202. In block 202, the one or more controllers 20 of the vehicle 12 monitor the current location of the vehicle 12 via the GPS 32, where the current location of the vehicle 12 corresponds to a current geofenced area 34 within the surrounding environment 14. The subscriber profile 30 corresponding to the prioritized cellular network 22 for the current geofenced area 34 is active to establish wireless communication between the vehicle 12 and the prioritized cellular network 22. The method 200 may then proceed to decision block 204.

In decision block 204, the one or more controllers 20 of the vehicle 12 continue to monitor the current location of the vehicle 12 until determining the vehicle 12 is leaving the current geofenced area 34 for a new geofenced area 34. In response to determining the vehicle 12 is leaving the current geofenced area 34 for a new geofenced area 34, the method 200 may proceed to decision block 206.

In decision block 206, the one or more controllers 20 determine if the new geofenced area 34 is declared as a disaster area. In response to the one or more controllers 20 determining the new geofenced area 34 is declared as a disaster area, the method 200 proceeds to block 208. Otherwise, the method 200 proceeds to decision block 210. The disaster area represents a geographical region that has been officially determined to be eligible for emergency relief by a governmental or other relief agency due to natural or human-made disasters. Some examples of natural disasters include, but are not limited to, hurricanes, wildfires, floods, and earthquakes.

In block 208, in response to determining the new geofenced area 34 is declared as a disaster area, the one or more controllers 20 activate the subscriber profile 30 corresponding to the ideal cellular network 22 to establish wireless communication between the vehicle 12 and the ideal cellular network 22. Once the one or more controllers 20 determine the vehicle 12 has exited the disaster area, the method 200 may proceed to block 218.

Returning to decision block 206, the in response to determining the new geofenced area 34 has not been declared as a disaster area, the method proceeds to decision block 210. In decision block 210, the one or more controllers 20 determine if the vehicle 12 is initiating emergency communication while located in the new geofenced area 34. In response to the one or more controllers 20 determining the vehicle 12 is initiating emergency communication while located within the new geofenced area 34, the method 200 proceeds to block 212. Otherwise, the method 200 proceeds to decision block 214. It is to be appreciated that emergency communication is a telephone call or a short message service (SMS) text message, a packet connection such as a transmission control protocol/Internet protocol TCP/IP connection, and a message queuing telemetry transport (MQTT) connection. The emergency communication may be an occupant of the vehicle 12 requesting assistance or receiving vital information such as, for example, messages regarding missing or endangered individuals, or an automatic collision detection call.

In block 212, in response to determining the vehicle 12 is initiating the emergency communication, the one or more controllers 20 activate the subscriber profile 30 corresponding to the ideal cellular network 22 to establish wireless communication between the vehicle 12 and the ideal cellular network 22. Once the one or more controllers 20 determine the vehicle 12 has completed the emergency communication, the method 200 may proceed to block 218.

Returning to decision block 210, in response to determining the vehicle 12 is not initiating the emergency communication, the method proceeds to decision block 214. In decision block 214, the one or more controllers 20 determine if the vehicle 12 is performing a connected service feature that requires the highest level of cellular connectivity available while in the geofenced area 34. In response to the one or more controllers 20 determining the vehicle 12 is performing a connected service feature that requires the highest level of cellular connectivity reliability, the method 200 proceeds to block 216. Otherwise, the method 200 returns to block 202. The connected service feature represents an in-vehicle function that requires continuous cellular reception to send and receive data. Some examples of connected service features that require continuous cellular reception include, but are not limited to, supervised automated driving, remote driving (where an advisor is situated at a call center and is remotely driving the vehicle), and fully autonomous driving.

In block 216, in response to determining the vehicle 12 is performing the connected service feature that requires the highest level of cellular connectivity reliability, the one or more controllers 20 activate the subscriber profile 30 corresponding to the ideal cellular network 22 to establish wireless communication between the vehicle 12 and the ideal cellular network 22. Once the one or more controllers 20 determine the vehicle 12 has completed performing the connected service feature, the method 200 may proceed to block 218.

In block 218, the one or more controllers 20 may then switch from the ideal cellular network 22 to the prioritized cellular network 22 by activating the subscriber profile 30 corresponding to the prioritized cellular network 22 to re-establish wireless communication between the vehicle 12 and the prioritized cellular network 22, in the event the ideal cellular network 22 is different than the prioritized cellular network 22. The method 200 may then terminate or return to block 202.

Determining the ideal cellular network 22 by the one or more remote computers 24 shall now be described. Referring back to FIG. 1, the one or more remote computers 24 are in wireless communication with each of the cellular networks 22 and each of the plurality of crowdsourced vehicles 28, where the one or more remote computers 24 rank the cellular performance of the plurality of cellular networks 22 based on crowdsourcing cellular performance data collected by the plurality of crowdsourced vehicles 28 to identify the ideal cellular network 22. Each crowdsourced vehicle 28 includes one or more controllers 120. The one or more controllers 120 of a crowdsourced vehicle 28 may perform a manual public land mobile network (PLMN) search to identify available cellular networks within the environment 14. Table 1 represents an exemplary list of the available cellular networks available that are determined by the one or more controllers 120 of a crowdsourced vehicle 28.

TABLE 1

| Index Number | Cellular Network Name |
|---|---|
| 0 | Network A |
| 1 | Network B |
| 2 | Network C |
| 3 | Network D |
| 4 | Network E |

Referring to both FIG. 1 and Table 1, the one or more controllers 120 identify each available cellular network by an index number. In one embodiment, the index number represents the last digit of a unique number for identifying a subscriber profile corresponding to an available cellular network. Some examples of unique numbers for identifying a subscriber profile include, but are not limited to, the integrated circuit card identification number (ICCID), the International Mobile Equipment Identity (IMEI), and the international mobile subscriber identity (IMSI). In the event the one or more controllers 120 lack a subscriber profile for a particular available cellular network, then the one or more controllers 120 may contact the one or more remote computers 24 for a downloadable copy of the subscriber profile. Table 1 also lists a cellular network name corresponding to each available cellular network. In the example as shown in Table 1, there are five cellular networks named Network A, Network B, Network C, Network D, and Network E that correspond to the cellular networks 22A-22E shown in FIG. 1.

It is to be appreciated that the one or more controllers 120 of each crowdsourced vehicle 28 may then evaluate each available cellular network based on one or more cellular connectivity parameters to identify an individual ideal cellular network. In other words, the cellular network 22 having highest-ranked cellular performance is determined based on one or more cellular connectivity parameters. Some examples of the cellular connectivity parameters that are indicative of the ideal cellular network 22 include, but are not limited to, a received signal strength indicator (RSSI) and a bit error rate. In the example as shown in Table 1, the individual ideal cellular network includes the index number 3. Once the one or more controllers 120 of an individual crowdsourced vehicle 28 identifies the individual ideal cellular network, the one or more controllers 120 may then transmit a message to the one or more remote computers 24 indicating the individual ideal cellular network. The one or more remote computers 24 may then determine the ideal cellular network 22 by performing one or more data analytic techniques upon the individual responses from the plurality of crowdsourced vehicles 28 to identify the ideal cellular network 22. Some examples of factors that may be used to determine the ideal cellular network 22 include, but are not limited to, cellular signal strength, available cellular technology (3G, 4G, 5G, etc.), upload/download bandwidth, throughput, latency and stability and/or reliability of the connection. The ideal cellular network 22 may then be communicated to the one or more controllers 20 of the vehicle 12 via one of the cellular networks 22.

It is to be appreciated that the crowdsourced cellular performance data is collected from crowdsourced vehicles 28 that include more than one available subscriber profile while evaluating the cellular networks 22, or that include one subscriber profile but are not performing an in-vehicle function that requires connection to the ideal cellular network 22. For example, if a particular crowdsourced vehicle 28 includes one subscriber profile and is currently performing supervised automated driving or making an emergency telephone call, then the crowdsourced vehicle 28 is already connected to the ideal cellular network 22. Therefore, the crowdsourced cellular performance data would not include the particular crowdsourced vehicle 28 when determining the ideal cellular network 22.

Referring generally to the figures, the disclosed cellular communication system provides various technical effects and benefits. Specifically, the cellular communication system provides a vehicle with the ability to choose the most appropriate cellular network based on specific usage scenarios. Accordingly, when the vehicle is located in a disaster area, initiating emergency communication, or performing a connected service feature that requires the highest level of cellular connectivity reliability readily available, then the vehicle connects to the ideal cellular network having the highest-ranked cellular performance. Otherwise, the vehicle is normally connected to the most economical cellular network available.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A cellular communication system for a vehicle that wirelessly connects to one of a plurality of cellular networks, the cellular communication system comprising:
one or more controllers including a plurality of subscriber profiles that each correspond to one of the plurality of cellular networks, wherein each subscriber profile allows for the one or more controllers to establish wireless communication with a particular one of the plurality of cellular networks, and wherein the one or more controllers include one or more processors that execute instructions to:
monitor a current location of the vehicle, wherein the current location of the vehicle corresponds to a current geofenced area within a surrounding environment of the vehicle, and wherein a subscriber profile corresponding to a prioritized cellular network for the current geofenced area is active to establish wireless communication between the vehicle and the prioritized cellular network;
determine the vehicle is leaving the current geofenced area for a new geofenced area;
determine one of the following: the new geofenced area is declared as a disaster area, the vehicle is initiating emergency communication while located in the new geofenced area, and the vehicle is performing a connected service feature that requires the highest level of cellular connectivity available while in the new geofenced area; and
in response to determining one of the following: the new geofenced area is declared as a disaster area, the vehicle is initiating emergency communication while located in the new geofenced area, and the vehicle is performing the connected service feature, activate a subscriber profile corresponding to an ideal cellular network to establish wireless communication between the vehicle and the ideal cellular network.

2. The cellular communication system of claim 1, wherein the one or more controllers execute instructions to:
in response to determining one of the following: the vehicle has exited the disaster area, the vehicle has completed the emergency communication, and the vehicle has completed performing the connected service feature, switch from the ideal cellular network to the prioritized cellular network by activating the subscriber profile corresponding to the prioritized cellular network to re-establish wireless communication between the vehicle and the prioritized cellular network.

3. The cellular communication system of claim 1, wherein the emergency communication is one of the following: a telephone call, a short message service (SMS) text message, a packet connection, and a message queuing telemetry transport (MQTT) connection.

4. The cellular communication system of claim 1, wherein the connected service feature represents an in-vehicle function that requires continuous cellular reception to send and receive data.

5. The cellular communication system of claim 1, wherein the connected service feature includes one of the following: supervised automated driving, remote driving, and fully autonomous driving.

6. The cellular communication system of claim 1, wherein the ideal cellular network is determined based on evaluating crowdsourced cellular performance data collected by a plurality of crowdsourced vehicles.

7. The cellular communication system of claim 6, wherein the crowdsourced cellular performance data is is collected from crowdsourced vehicles that include one of the following: more than one available subscriber profile and one subscriber profile but the crowdsourced vehicle is not performing an in-vehicle function that requires connection to the ideal cellular network.

8. The cellular communication system of claim 1, wherein cellular connectivity parameters that are indicative of the ideal cellular network include a received signal strength indicator (RSSI) and a bit error rate.

9. The cellular communication system of claim 1, wherein the prioritized cellular network is a contracted cellular carrier for the vehicle.

10. The cellular communication system of claim 1, wherein the ideal cellular network includes a highest-ranked cellular performance when compared to each of the plurality of cellular networks.

11. The cellular communication system of claim 1, wherein the vehicle is an automobile.

12. The cellular communication system of claim 1, wherein the vehicle is one of the following: a drone, a military vehicle, a marine vehicle, and an aircraft.

13. The cellular communication system of claim 1, wherein the one or more controllers of the vehicle store a list of available geofenced areas within the surrounding environment in memory.

14. The cellular communication system of claim 13, wherein each available geofenced area that is part of the list indicates at least one prioritized cellular network.

15. A method for wirelessly connecting a vehicle to one of a plurality of cellular networks, the method comprising:
monitoring, by one or more controllers, a current location of the vehicle, wherein the current location of the vehicle corresponds to a current geofenced area within a surrounding environment of the vehicle, and wherein the one or more controllers include a plurality of subscriber profiles that each correspond to one of the plurality of cellular networks and each subscriber profile allows for the one or more controllers to establish wireless communication with a particular cellular network;
determining the vehicle is leaving the current geofenced area for a new geofenced area, wherein a subscriber profile corresponding to a prioritized cellular network for the current geofenced area is active to establish wireless communication between the vehicle and the prioritized cellular network;
determining one of the following: the new geofenced area is declared as a disaster area, the vehicle is initiating emergency communication while located in the new geofenced area, and the vehicle is performing a connected service feature that requires the highest level of cellular connectivity available while in the new geofenced area; and
in response to determining one of the following: the new geofenced area is declared as a disaster area, the vehicle is initiating emergency communication while located in the new geofenced area, and the vehicle is performing the connected service feature, activating a subscriber profile corresponding to an ideal cellular network to establish wireless communication between the vehicle and the ideal cellular network.

16. The method of claim 15, further comprising:
in response to determining one of the following: the vehicle has exited the disaster area, the vehicle has completed the emergency communication, and the vehicle has completed performing the connected service feature, switching, by the one or more controllers from the ideal cellular network to the prioritized cellular network by activating the subscriber profile corresponding to the prioritized cellular network to re-establish wireless communication between the vehicle and the prioritized cellular network.

17. A cellular communication system for a vehicle that wirelessly connects to one of a plurality of cellular networks, the cellular communication system comprising:
one or more controllers including a plurality of subscriber profiles that each correspond to one of the plurality of cellular networks, wherein each subscriber profile allows for the one or more controllers to establish wireless communication with a particular cellular network, and wherein the one or more controllers include one or more processors that execute instructions to:
monitor a current location of the vehicle, wherein the current location of the vehicle corresponds to a current geofenced area within a surrounding environment of the vehicle, and wherein a subscriber profile corresponding to a prioritized cellular network for the current geofenced area is active to establish wireless communication between the vehicle and the prioritized cellular network;
determine the vehicle is leaving the current geofenced area for a new geofenced area;
determine one of the following: the new geofenced area is declared as a disaster area, the vehicle is initiating emergency communication while located in the new geofenced area, and the vehicle is performing a connected service feature that requires the highest level of cellular connectivity available while in the new geofenced area;
in response to determining one of the following: the new geofenced area is declared as a disaster area, the vehicle is initiating emergency communication while located in the new geofenced area, and the vehicle is performing the connected service feature, activate a subscriber profile corresponding to an ideal cellular network to establish wireless communication between the vehicle and the ideal cellular network; and
in response to determining one of the following: the vehicle has exited the disaster area, the vehicle has completed the emergency communication, and the vehicle has completed performing the connected service feature, switch from the ideal cellular network to the prioritized cellular network by activating the subscriber profile corresponding to the prioritized cellular network to re-establish wireless communication between the vehicle and the prioritized cellular network.

18. The cellular communication system of claim 17, wherein the emergency communication is one of the following: a telephone call, a SMS text message, a packet connection, and a MQTT connection.

19. The cellular communication system of claim 17, wherein the connected service feature represents an in-vehicle function that requires continuous cellular reception to send and receive data.

20. The cellular communication system of claim 17, wherein the ideal cellular is determined based on evaluating crowdsourced cellular performance data collected by a plurality of crowdsourced vehicles.
